(19) United States
(12) Patent Application Publication
(10) Pub. No.: US 2009/0290648 A1
(43) Pub. Date: Nov. 26, 2009

(54) METHOD AND A DEVICE FOR TRANSMITTING IMAGE DATA

(75) Inventors: Patrice Onno, Rennes (FR); Fabrice Le Leannec, Mouaze (FR); Xavier Henocq, Melesse (FR)

Correspondence Address: FITZPATRICK CELLA HARPER & SCINTO, 1290 Avenue of the Americas, NEW YORK, NY, 10104-3800, US

(73) Assignee: Canon Kabushiki Kaisha, Tokyo (JP)

(21) Appl. No.: 12/468,343

(22) Filed: May 19, 2009

(30) Foreign Application Priority Data
May 20, 2008 (FR) 0853281

(51) Int. Cl. H04N 7/64

(52) U.S. Cl. 375/240.27; 375/E07.026; 375/E07.279

(57) ABSTRACT

The method of transmitting image data of a sequence of images comprises, for at least one image of said sequence of images:

a step of coding an initial image at a first resolution,
a step (602, 607) of determining a corrective signal representing the difference between the image temporally following the initial image at a second resolution and an image at the second resolution calculated from the initial image at the first resolution,

a step (603, 604, 608, 609) of coding said corrective signal and

a step of transmitting the coded image at the first resolution and the coded corrective signal.

The present invention concerns a method and a device for transmitting image data. The technical field of the invention concerns, more particularly, the streaming of hierarchical video of SVC type (SVC being an acronym for “Scalable Video Coding”) and its uses in the context of video transmission, which is often referred to as video streaming.

The future SVC standard for hierarchical video compression is an extension of the H.264 video standard. This SVC extension aims to provide new functionalities, relative to the H.264 standard, while maintaining an excellent compression rate. These new functionalities mainly concern spatial scalability (adaptability), temporal scalability and quality scalability. More specifically, on the basis of a single SVC stream, it will be possible to extract substreams corresponding to lower spatial resolutions, lower frame rates and lower qualities.

A characteristic example is to compress a 720×576 high spatial definition video, that is to say of 576 rows of 720 pixels, or image points, and that comprises 60 frames per second. This video format of 720×576 spatial resolution, at 60 Hz will then be decodable with an apparatus having good decoding capabilities such as a computer or a television set provided with an internal or external decoder. By virtue of the SVC standard, it is also possible, on the basis of this SVC stream, to extract a substream corresponding to smaller image sizes requiring less decoding power. For example, on the basis of the compressed file of the 720×576, 60 Hz sequence, a video of 180×144 resolution (four times smaller in width and in height) comprising 7.5 frames per second can be extracted. On account of this, this substream is more easily decodable by an apparatus of low capability such as a portable telephone.

In the context of an application for video broadcast of streaming type between a server system and a client via a network, the SVC standard has considerable advantages when adapting to the conditions of the network is concerned, in particular to take into account the variation in the bandwidth.

However, according to the SVC standard, when a change in resolution is made at the decoder, the reference images of the new spatial resolution have not been decoded. Temporal drift appears when a change in spatial resolution occurs during the decoding. This drift is the consequence of a change in the reference images during motion compensation carried out by the decoder.

Today, the SVC decoder of reference, called JSVM, does not easily enable passage from one spatial resolution to another spatial resolution during decoding. It is necessary to introduce solutions enabling the passage from one spatial resolution to another. Intuitively, simple and immediate solutions may be implemented to re-synchronize the decoder with the desired spatial resolution. In particular, two solutions are possible. The first is based on IDR image use (IDR being an acronym for “Instantaneous Decoding Refresh”), the second is based on the decoding of so-called “key” images.

If a video is coded in real time, it is still possible to insert IDR images which are so-called “Intra” images in the desired spatial resolution, in order to avoid any temporal dependency existing with the past images. This solution easily applies for “real time” coding operations, in which, immediately after detection of a change of spatial resolution, an IDR image can be inserted into the target spatial resolution in order to reduce the drift. Where the SVC videos are pre-coded, it is necessary to insert IDR images into the SVC stream quite frequently in order to enable the passage from one spatial resolution to another during future decoding operations. This must also be provided in all the spatial resolutions of the SVC stream to enable any particular change in spatial resolution.

However, the frequent insertion of IDR images into the video stream penalizes the coding efficiency of the video sequence since the associated coding cost is high.

The object of using so-called “key” images is the same as that for IDR images: the use of these images enables the SVC streams to be re-synchronized in order to limit the drift induced by the change in spatial resolution. In SVC terminology, “key” images are images of the lower layers which are used for the inter-layer prediction. The insertion of “key” images in an SVC stream affects the decoding efficiency less since these images are in general predicted images called “P” images of which the coding cost is low. However, the particularity of “key” images is the following: a decoding loop is maintained relative to the spatial layers using the “key” images. More particularly, instead of performing the full decoding of a lower layer, only the “key” images are decoded. This solution has the drawback of having to perform a decoding loop in the lower layers to rapidly access those images. This makes the decoder more complex since motion compensation must be applied and additional memories to store those decoded “key” images are necessary.

In the H.264 standard, two items of syntax have been defined to define two types of slices to make the transition between two distinct H.264 streams. The switching slices called “SP” and “SI” have been defined to make the link between two bitstreams of the same spatial resolution. This sophisticated stream switching makes it possible to perform variable rate video streaming. When a decoder jumps from one stream to another, in the middle of a video stream, it may synchronize itself using the switching slices, with the images present at that location, despite the use of other images (or no images) as references prior to the movement. However, the spatial resolutions must be identical.

At the time of standardization of the SVC standard, a technical proposal was made by J. Jia, H. C. Choi, and J. G. Kim. “SP-picture for SVC” (Technical Report JVT-T022, Sejong Univ. and ETRI, 20th JVT Meeting, Klagenfurt, Austria, July 2006), to include new types of slices to perform switching between two spatial layers. This proposal was not adopted. However, those SP or SI slices as defined in that paper are merely means for switching, which must be known to the decoder and may therefore not be use on a wide scale if they are not standardized.

The present invention aims to mitigate these drawbacks.

To that end, according to a first aspect, the present invention concerns a method of transmitting image data of a sequence of images, characterized in that comprises, for at least one image of said sequence of images:

a step of coding an initial image at a first resolution,

a step of determining a corrective signal representing the difference between the image temporally following the initial image at a second resolution and an image at the second resolution calculated from the initial image at the first resolution,

a step of coding said corrective signal and

a step of transmitting the coded image at the first resolution and the coded corrective signal.

By virtue of these provisions, the recipient of the coded data may, on switching between the first resolution and the second resolution, in order to constitute an image at the second resolution, decode the preceding image at the first resolution, modify the sampling of the decoded image, and correct the image so re-sampled, possibly motion-compensated with addition of a residue, with the corrective signal. An operation of switching resolution is thus easy. Correction is thereby made of the error introduced by the temporal drift when a change in spatial resolution occurs during the decoding. An advantage of the implementation of the present invention is to maintain the initial quality of all the images of the spatial resolutions in course of decoding. It makes it possible in particular to correct the behavior of the decoder in order to maintain a good quality in course of the decoding on passage between two spatial resolutions of a video sequence, for example coded in SVC format.

The advantages of the implementation of the present invention comprise that:

the change in spatial resolution may be carried out very efficiently and at a reasonable cost, in processing and/or rate terms,

the coding cost is much lower than for an IDR image and

it is not necessary to insert so-called “key” images which require the setting up of decoding with motion compensation in all the layers, for which several decoding loops are necessary (known as “multi loop decoding”).

According to particular features, during the step of determining a corrective signal, the corrective signal is determined as being an image equal to the difference between:

the following image at the second resolution and

the sum of:
the initial image at the first resolution, coded and decoded at the first resolution, re-sampled to reach the second resolution and compensated with the compensation between the reference image of the following image and the following image at the second resolution and
a residue at the second resolution.

By virtue of these provisions, the first image is calculated directly at the new resolution, without having to calculate the reference image at that new resolution.

According to particular features, during the step of determining a corrective signal, the corrective signal represents the difference between the initial image at the first resolution re-sampled at the second resolution and a reference image of the following image coded at the second resolution.

According to particular features, the method of the present invention, as succinctly set forth above further comprises a step of detecting spatial resolution change, at the decoder, to reach a second resolution on the basis of the image following the initial image, the step of determining the corrective signal being carried out after the detecting step.

The coder thus takes into account the need of the decoder and does not have to perform corrective signal calculation for all the images of the sequence of images.

According to particular features, for images of an image stream, for at least one possible change in spatial resolution, the error determining step, the step of coding a corrective signal for said error and a step of conjoint memory storage of the coded corrective signal and of the coded images to constitute a data stream to transmit, are regularly performed, and during the transmitting step, a coded corrective signal is only transmitted in case of detection of resolution change.

This particular embodiment is particularly adapted to the case of the coding of the sequence before storage for later transmission, for example in the case of pre-coded videos. The current image coding units are generated, earlier than the transmission, ready for possible changes in spatial resolution.

According to particular features, during the step of coding the corrective signal, the corrective signal is associated with a specific identifier. The decoder may thus easily locate the corrective signal and, possibly, a change in spatial resolution.

According to particular features, the coding of the corrective signal is carried out by coding unit and the specific identifier is inserted in a header of each coding unit representing the corrective signal. It is thus possible to take advantage of standardized header fields to specify discardable or proprietary information.

According to particular features, during each coding step, an image is coded with a hierarchical format.

According to particular features, during each coding step, SVC coding is used (SVC being an acronym for “Scalable Video Coding”).

According to particular features, during the step of coding the corrective signal, at least one SVC coding unit is created encapsulating the corrective signal in at least one item of syntax to create an optional coding unit in the data stream.

Thus, the coding units containing the corrective signal are inserted into the pre-existing SVC stream. It is thus possible to pass from one spatial resolution to another by using an item of SVC syntax. By this additional means, the error due to the temporal drift is eliminated and the decoding quality is preserved even if the reference images for the motion compensation are different on changing spatial resolution.

Furthermore, by virtue of these provisions, it is possible to re-use an item of SVC syntax of which the particularity is that it is optional. Advantageously, the transmission of these coding units containing the corrective signal is “transparent” relative to the network: the corrective coding units are conveyed in the same manner as the normal coding units. There is no parallel channel to convey them and the addition of a new item of syntax is not necessary.

According to a second aspect, the present invention concerns a method of receiving image data of a sequence of images, characterized in that comprises, for at least one image of said sequence of images:

a step of decoding an initial image at a first resolution,

a step of decoding a corrective signal representing the difference between the image temporally following the initial image at a second resolution and an image at the second resolution calculated from the initial image at the first resolution and

a step of decoding the following image, at the second resolution, by using the initial image decoded at the first resolution and said corrective signal.

According to particular features, the receiving method of the present invention as succinctly set forth above further comprises a step of detecting change in spatial resolution, during which the reception of a said coded corrective signal is detected, the step of decoding the corrective signal and the step of decoding the following image being carried out after detection of a change of spatial resolution.

According to particular features, during the decoding of the following image, the following image is determined as equal to the sum of:

a corrective image represented by the corrective signal and

the sum of:
the initial image at the first resolution re-sampled to reach the second resolution and compensated with the compensation between the reference image of the following image and the following image at the second resolution and
a residue at the second resolution.

According to a third aspect, the present invention concerns a device for transmitting image data of a sequence of images, characterized in that it comprises:

a means for coding an initial image at a first resolution,

a means for determining a corrective signal representing the difference between the image temporally following the initial image at a second resolution and an image at the second resolution calculated from the initial image at the first resolution,

a means for coding said corrective signal and

a means for transmitting the coded image at the first resolution and the coded corrective signal.

According to a fourth aspect, the present invention concerns a device for receiving image data of a sequence of images, characterized in that it comprises:

a means for decoding an initial image at a first resolution,

a means for decoding a corrective signal representing the difference between the image temporally following the initial image at a second resolution and an image at the second resolution calculated from the initial image at the first resolution and

a means for decoding the following image, at the second resolution, by using the initial image decoded at the first resolution and said corrective signal.

According to a fifth aspect, the present invention concerns a computer program loadable into a computer system, said program containing instructions enabling the implementation of the method of the present invention as succinctly set forth above.

According to a sixth aspect, the present invention concerns an information carrier readable by a computer or a microprocessor, removable or not, storing instructions of a computer program, characterized in that it enables the implementation of the method of the present invention as succinctly set forth above.

As the advantages, objects and particular features of this receiving method, of these devices, of this program and of this information carrier are similar to those of the transmitting method, as succinctly set forth above, they are not reviewed here.

Other particular advantages, objects and features of the present invention will emerge from the following description, given, with an explanatory purpose that is in no way limiting, with reference to the accompanying drawings, in which:

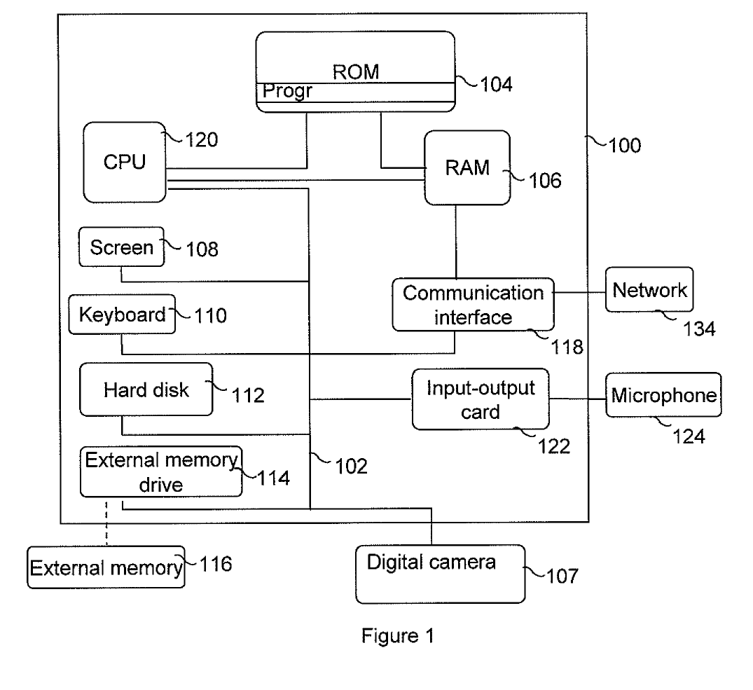

FIG. 1 is a diagram of a particular embodiment of the device of the present invention,

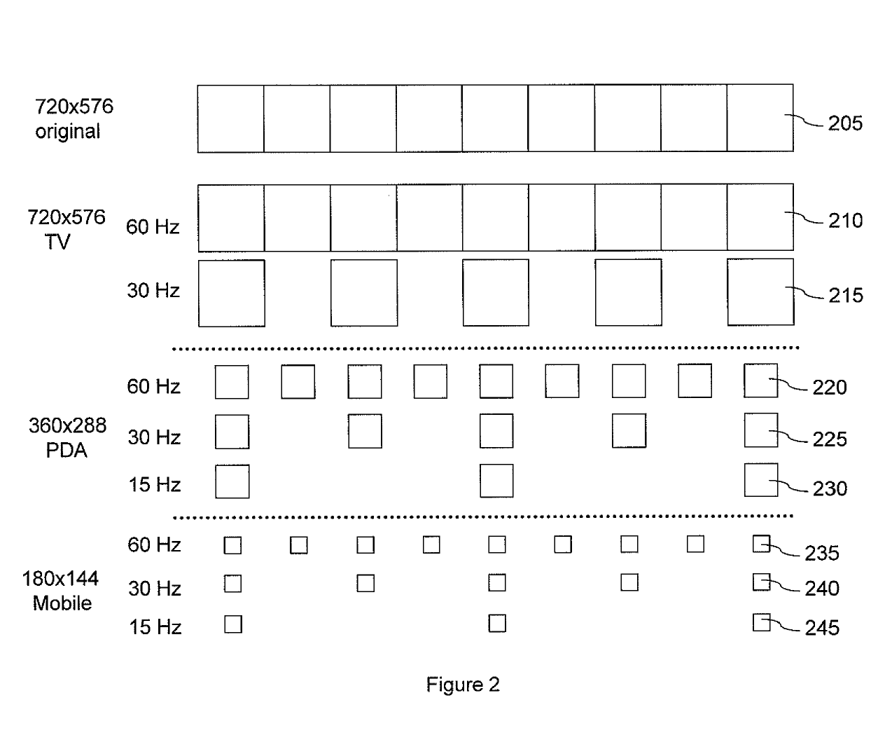

FIG. 2 is a diagram of images of a video sequence and of layers representing those images,

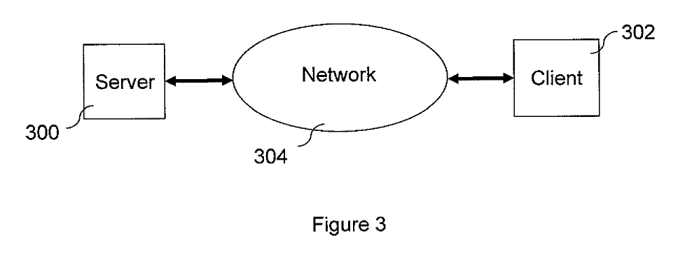

FIG. 3 represents a server and a client linked together by a network,

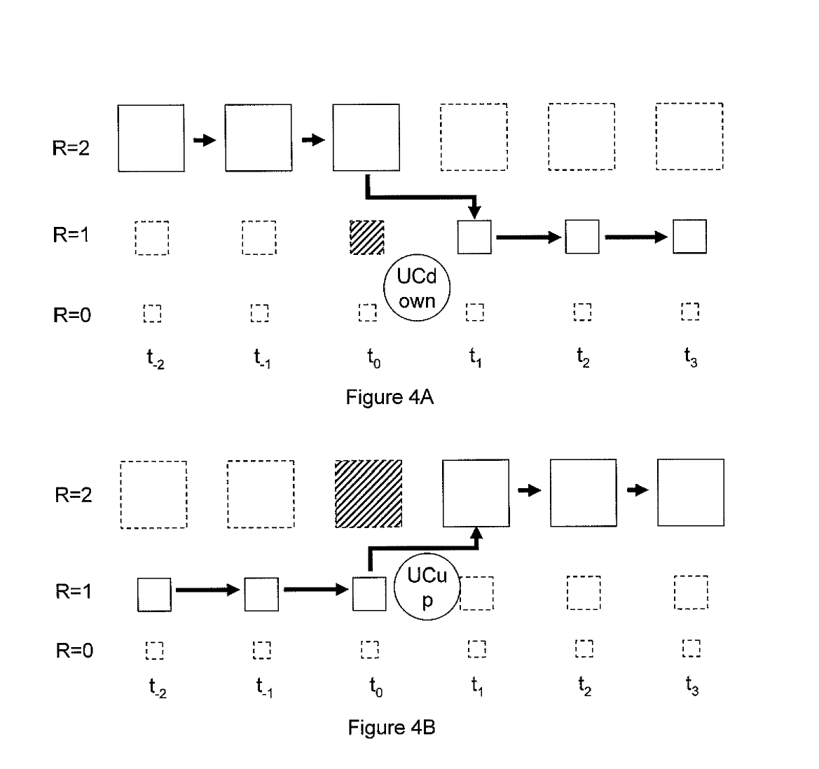

FIGS. 4A and 4B respectively represent falling and rising changes in spatial resolution levels and

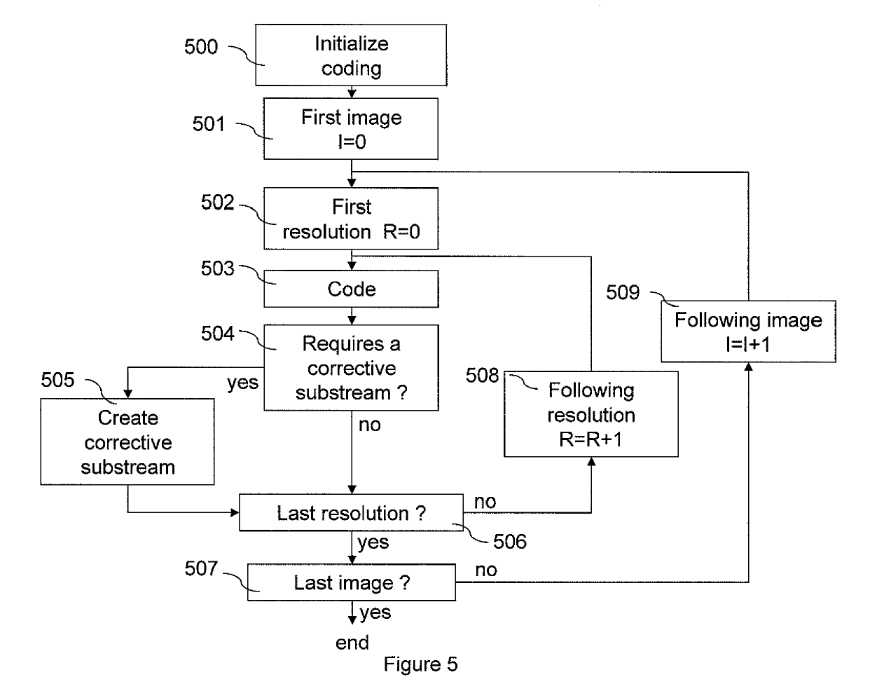

FIGS. 5 to 7 are logigram representations of the steps of a particular embodiment of the method of the present invention.

It can be seen in FIG. 1 that, in a particular embodiment, the device of the present invention takes the form of a micro-computer 100 provided with a software application implementing the method of the present invention and different peripherals. The device is constituted here by a server adapted to transmit coded images to clients (not shown).

The micro-computer 100 is connected to different peripherals, for example a means for image acquisition or storage 107, for example a digital camera or a scanner, connected to a graphics card (not shown) and providing image information to compress and transmit. The micro-computer 100 comprises a communication interface 118 connected to a network 134 able to transmit digital data to be compressed and to transmit data compressed by the micro-computer. The micro-computer 100 also comprises a storage means 112 such as a hard disk. The micro-computer 100 also comprises a diskette drive 114. An external memory, or “stick” comprising a memory 116 (for example a stick referred to as “USB” in reference to its communication port), as the storage means 112, may contain compressed data or data to compress. The external memory 116 may also contain instructions of a software application implementing the method of the present invention, which instructions are, once read by the micro-computer 100, stored in the storage means 112. According to a variant, the program enabling the device to implement the present invention is stored in read only memory 104 (denoted “ROM” in FIG. 1). In a second variant, the program is received via the communication network 134 and is stored in the storage means 112. The micro-computer 100 is connected to a microphone 124 via the input/output card 122. The micro-computer 100 has a screen 108 making it possible to view the data to compress or serving as interface with the user, with the help of a keyboard 110 or any other means (a mouse for example).

Of course, the external memory 116 may be replaced by any information carrier such as CD-ROM (acronym for compact disc-read only memory) or a memory card. More generally, an information storage means, which can be read by a computer or by a microprocessor, integrated or not into the device, and which may possibly be removable, stores a program implementing the method of the present invention.

A central processing unit 120 (designated CPU in FIG. 1) executes the instructions of the software implementing the method of the present invention. On powering up, the programs enabling implementation of the method of the present invention which are stored in a non-volatile memory, for example the ROM 104, are transferred into the random-access memory RAM 106, which then contains the instructions of that software as well as registers for storing the variables necessary for implementing the invention.

A communication bus 102 affords communication between the different elements of the microcomputer 100 or connected to it. The representation of the bus 102 is non-limiting. In particular, the central processing unit 120 is capable of communicating instructions to any element of the device directly or via another element of the device.

FIG. 2 diagrammatically represents new functionalities offered by the SVC standard. In particular, it shows the different temporal and spatial scalabilities which may be obtained. In this particular example, from a video sequence 205 of 720×576 format originally composed of 60 frames per second, it is possible to code (and in turn to decode):

a lower spatial resolution, images 220, 225 and 230, of which the size here is equal to 360×288, which typically corresponds to the screen resolution of a PDA (acronym for “Personal Digital Assistant”).

a still lower spatial resolution, images 235, 240 and 245, of which the size here is equal to 180×144, which typically corresponds to the screen resolution of a mobile telephone.

Similarly, for the same spatial resolution (720×576), it is possible to code (and subsequently to decode) different dyadic temporal representations: 60 Hz (images 210, 220 and 235), 30 Hz (images 215, 225 and 240), 15 Hz (images 230 and 245). The number of temporal representations is also chosen by the user at the time of coding.

These various spatial and temporal representations are available for any spatial resolution and frame rate and not only for those illustrated in FIG. 2.

Finally, for each image of the illustrated sequences, the standard makes it possible to attribute a variable rate to each image and thus to provide scalability in terms of quality.

Of course, the concept of spatial scalability is used to aim at sizes of image receivers commonly used when viewing videos. The example of this Figure shows ratios of two between successive spatial resolutions, but it is to be noted that the standard is not limited to resolutions of which the ratios are equal to two. Moreover, the ratios may be different for the height and the width of the images.

In a video streaming context (continuous video stream) it is the compressed data units corresponding to these different images that are conveyed over the network.

As illustrated in FIG. 3, the invention concerns the adaptation of a video digital signal which may advantageously be implemented between two communication apparatuses, one designated “server”, referenced 300, which supplies coded images to the other, designated “client”, referenced 302, via a communication network 304. In the context of the invention, the server 300 possesses a digital signal to transmit, in coded form, to the remote client 302 via the network 304. The server has means making it adapted to calculate a corrective signal adapted to eliminate the drift introduced in case of resolution change. The client 302 is a video signal receiver and possesses means which make it adapted to carry out, on the received signal, decoding that is adapted to eliminate the drift introduced by the change in spatial resolution using the corrective signal transmitted by the server.

In the context of video streaming applications, the conventional transmission protocols are called into play between the server 300 and the client 302. In particular, the server 300 and the client 302 use the RTSP protocol (RTSP being an acronym for “Real Time Streaming Protocol”) to control the display of the video sequence. By virtue of the RTSP protocol, the client may specify the video to transmit to a remote server by specifying its URI (acronym for “Uniform Resource Identifier”). The characteristics of the video are also transmitted from the server 300 to the client 302 in order for the decoder to know those characteristics. Other useful information may thus be communicated between the server 300 and the client 302 using the RTSP protocol. Furthermore, an underlying protocol, RTP (acronym for “Real Time Protocol”) is also used to transmit the coded data of the SVC video sequence in real time. The RTP protocol also relies on the definition of an SVC payload to make the SVC coding units match the form of RTP network packets.

In the rest of the description and for the purposes of simplification, only one change in resolution level will be envisaged. A change of several levels at a time will be considered as several changes from a single level. FIGS. 4A and 4B present two possible cases of increase and reduction in spatial resolution. The Figures here illustrate three possible spatial resolution levels R=0, R=1 and R=2 having the same temporal resolutions. The arrows represented in FIGS. 4A and 4B link the images successively supplied as output by the decoder, for example for immediate display or storage, these images being represented in continuous lines. The images represented in dashed lines are not supplied as output from the decoder. The cross-hatched images represent the reference images missing for the decoding of the first image (time t1) in the resolution following a change in resolution, this change taking place as from time t0.

FIG. 4A presents a case in which a reduction in the temporal resolution is made at the time t0. The target spatial resolution layer of level R=1 is thus passed to from the initial spatial layer of level R=2. According to the invention, a particular reference image is used at the time of the motion compensation for a change in spatial resolution. The addition of a corrective coding unit “UCdown” to the image corresponding to the time t1, (that is to say the image following the image at which the reduction in resolution is started) of the target spatial resolution layer of level R=1 is also taken into account in order to correct the error generated by the motion compensation drift. More particularly, on coding, the image t1 of the target spatial resolution of level R=1 is predicted from at least one image of the same resolution preceding the image at the time t1. In the description below, a single reference image is considered. However, the invention also applies to the case in which there are several reference images and the adaptation of the means and steps described below to this case poses no difficulty to the person skilled in the art. As illustrated in FIG. 4A the images represented in dashed lines t-2 to t0 are not available. This is because, although the coding units are available for the decoder in the bitstream, they are not decoded. The motion compensation loop is thus not carried out at the decoder. They cannot therefore be used as reference for the prediction of the image t1.

The invention aims to correct this lack by relying on the images of the initial spatial resolution, of level R=2. The corrective coding unit UCdown enables correction of the error introduced by the use of a reference image from the initial spatial resolution layer of level R=2 instead of the image really used to perform the coding of the image t1 of the target spatial resolution layer of level R=1. FIGS. 5 to 7 describe the steps of creating the corrective coding units UCdown.

FIG. 4B presents the case in which an increase in the temporal resolution is made at the time t0. The target spatial resolution layer of level R=2 is thus passed to from the initial spatial resolution layer of level R=1. According to the invention, in the same way as in the preceding case, particular processing is carried out for the motion compensation. Account is also taken of the addition of a corrective coding unit UCup to the image t1 of the target spatial resolution layer, of level R=2, in order to correct the error generated by the motion compensation drift.

FIG. 5 describes the main steps for implementing the invention at the server where an SVC type coder is used.

During a step 500, an initialization is carried out for the coding of the video sequence of SVC type at which various coding parameters are set. These coding parameters concern, for example, the number of spatial resolutions of the stream, the temporal resolutions chosen, the value of the quantization step size for each layer and/or the structure of the GOPs (GOP being an acronym for “Group of Pictures”). These parameters typically correspond to the configuration files of the SVC reference software coder called “JSVM”.

During a step 501, an image counter for the sequence “I” is initialized to 0. During a step 502, a counter “R” is initialized to “0” in order to process the resolutions chosen for the coding. For example, there are three resolutions in FIGS. 2, 4A and 4B.

During a step 503, the coding of the image of index I and resolution R is carried out, as would be the image in a coder of SVC type with the chosen coding parameter values.

During a step 504, it is determined whether a corrective coding unit must be inserted to eliminate the effects of the drift caused by a change in resolution. A change in spatial resolution may be requested either:

by the user, at the client, for example by means of a graphical interface. A means for communication between the client and the server enables the coder to be informed so as to carry out the necessary changes corresponding to the change in resolution desired by the client;

by a rate control system directly linked to the coder. In this case, it is possible that, for rate control needs, the rate control system passes from one spatial resolution to another without action by the client.

In this step 504, two distinct cases or scenarios may be distinguished:

where the full coding of the sequence is carried out before any transmission, a storage of the pre-coded videos prior to any streaming/transmission (case of pre-coded videos), step 504 consists of complying with the predetermined frequency F for apparition of the corrective coding units. More particularly, in this specific case, it is not possible on coding to determine the future changes in spatial resolution at the decoder. In this mode, it therefore suffices to provide these corrective coding units UCdown and UCup quite frequently in order to be able to pass rapidly from one resolution to another. For example, a corrective image substream may be associated with all the images (F=1), every two images (F=2) or every three images (F=3). It is to be noted that on transmission (streaming) of this video, the corrective coding units UCdown or UCup are only transmitted at the time of an actual change in resolution concerning them. These UCdown and UCup corrective coding units are generated in readiness for possible changes in spatial resolution. They are identified by the setting to “1” of a bit that is specific to each NAL unit which encapsulates them, which gives the advantage of considering them as optional as set out below. It is also noted that it is necessary to provide the corrective coding units UCdown and UCup for an image in the case of a reduction or an increase in the resolution in the spatial layers enabling this. Typically, if the video sequence comprises three spatial resolutions as illustrated in FIGS. 4A and 4B only one corrective coding unit UCup for the case of a reduction in spatial resolution is associated with the first layer R=0, for the selected images (it is noted that the corrective unit is associated with the final resolution and not with the initial resolution). On the other hand, the intermediate layer of resolution R=1 comprises two corrective coding units UCdown and UCup in order to provide either for a reduction in the spatial resolution or for an increase in the spatial resolution. Lastly, for the highest resolution, R=2, a single corrective coding unit UCup is necessary and corresponds to the case of an increase in resolution;

in the particular case where the video is coded in real time, the coder generates, slightly in advance, the coded images before the decoder receives them and decodes them. In this case, the coder may react immediately to the changes in spatial resolution by producing the corrective coding unit as soon as a change in spatial resolution is requested. It is noted that the corrective coding units are thus automatically created depending on the real changes in resolution made at the decoder.

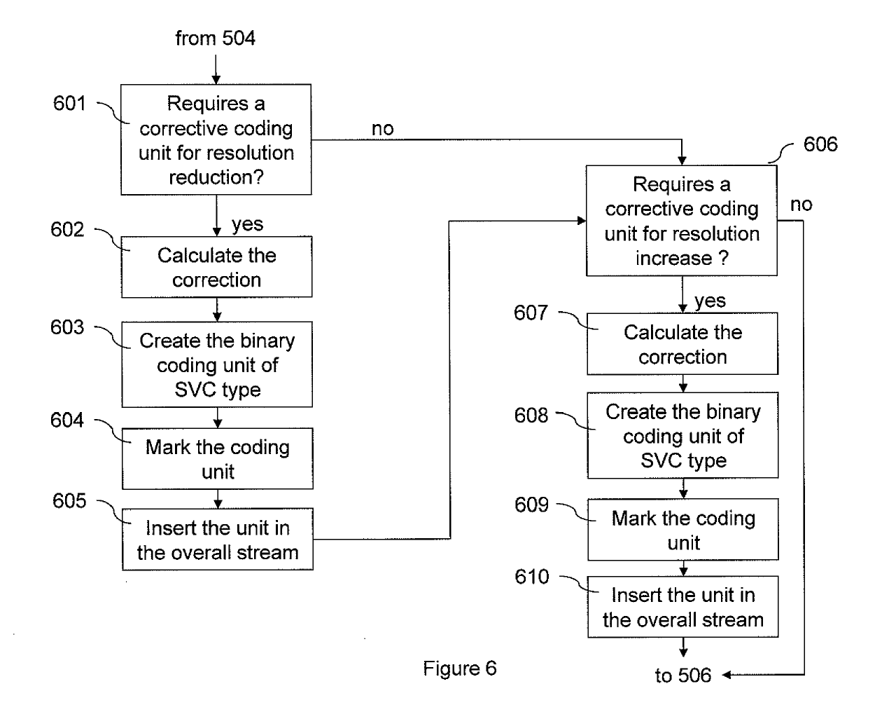

If it is not necessary to create a corrective coding unit, step 506 is proceeded to. If it is necessary to create a corrective coding unit, during a step 505 the corrective coding unit is created, as described with reference to FIG. 6.

During the step 506, it is determined whether the processing of the last resolution of that image has been carried out. If the result of step 506 is negative, during a step 508 the following resolution is proceeded to by incrementing the variable R, then step 503 is returned to. If the result of step 506 is positive, a step 507 is proceeded to during which it is determined whether the image processed is the last image to code for the video sequence in course of processing. If the response is positive the coding of the sequence is terminated. Otherwise, a step 509 is proceeded to during which the variable I is incremented to 1 to pass to the following image of the video sequence, then step 502 is returned to.

In a video streaming application, the codestream comprising the coded image and the corrective substream, if such a substream has been created, is transmitted to a client device, prior to step 507.

In an application for full coding of a sequence and later transmission, the processing of the sequence is finalized. A step of transmitting the whole of the coded stream comprising the coded images and the corrective substreams created takes place after the finalization of the algorithm of FIG. 5.

FIG. 6 represents the sub-steps of step 505 of FIG. 5. During a step 601, it is determined whether a corrective substream must be created for a reduction in spatial resolution. If the result of step 601 is negative, a step 606 described later is proceeded to directly. If the result of step 601 is positive, a step 602 is proceeded to during which a corrective coding unit UCdown is determined for a reduction in resolution.

Step 602 consists of calculating the correction image or corrective signal generated by the drift in the case of a reduction in resolution. This correction image Corr(I_{R}(t)) is calculated in the following manner, when the resolution R (resolution for the image at time t) is passed to from the resolution R+1 (resolution of the image for the time t−1).

Corr(I_{R}(t)=I_{R}(t)−Comp_{[I}_{_{R}}_{(t-1)→(t)]}{Down(I_{R+1}(t−1)}−Res(I_{R}(t) (1)

In which equation I_{R}(t) is the reconstructed image of resolution R at the time t and Comp_{[I}_{_{R}}_{(t-1)→I}_{_{R}}_{(t)]} corresponds to the motion compensation.

It is noted that, where there is no resolution change, the image I_{R}(t) is conventionally obtained at the coder by motion compensation of the preceding image, for the time t−1 in the resolution R, designated “reference image” to which a residue image Res(I_{R}(t)) is added.

The corresponding equation is the following:

I_{R}(t)=Comp_{[I}_{_{R}}_{(t-1)→I}_{_{R}}_{(t)]}+Res(I_{R}(t) (2)

However, when a reduction in resolution is carried out at the time t, the image of the new resolution at the preceding time, I_{R}(t−1), is not available at the decoder, and thus an approximation of that image must be calculated. In the example given here, this approximation is a version, downsampled to reach the new resolution R, of the reference image at the resolution R+1, which is available: this is the term Down(I_{R+1}(t−1)).

As this downsampled reference image is different from the reference image for the resolution R, I_{R}(t−1), the correction image Corr(I_{R}(t)) of resolution R is calculated to reduce that difference in order to reduce the drift from the motion compensation.

Next, during a step 603, this correction image Corr(I_{R}(t)) is coded in a coding unit (UCdown), as conventionally coded in the SVC standard, by using the steps of transformation, quantization and entropy encoding.

During a step 604, the newly created coding unit is marked as a “discardable” coding unit. Such a unit is qualified as “discardable” when it is not necessary for the reconstruction of the following coding units of the spatial layer in course and the following layers. The invention uses this particular property of the “discardable” coding units, since their specific content cannot serve for the reconstruction of other units given that they contain correction information. This property also makes it possible to include these corrective coding units only when needed: they are not transmitted if there is no change in spatial resolution. Consequently, they do not penalize the coding cost, in contrast to the IDR images known from the prior art, for example.

To mark a coding unit, the “discardable_flag” field is set to the value “1” in the coding unit header. The table below gives the description of a coding unit (or NAL unit) header, as described in the SVC standard.

| Fields | number of bits | No. of the byte |
|---|---|---|
| Reserved_one_bit | 1 | 1 |
| idr _flag | 1 | 1 |
| priority_id | 6 | 1 |
| no_inter_layer_pred_flag | 1 | 2 |
| dependency_id | 3 | 2 |
| quality_id | 4 | 2 |
| temporal_id | 3 | 3 |
| use_ref_base_pic_flag | 1 | 3 |
| discardable_flag | 1 | 3 |
| output_flag | 1 | 3 |
| reserved_three_2bits | 2 | 3 |

Next, during a step 605, the coding unit so created is inserted in the SVC bitstream of the images already coded of the video sequence. It is noted that the coding unit is associated with the final resolution and not the initial resolution.

Next a step 606 is proceeded to during which it is determined whether it is necessary to create a corrective coding unit for the resolution increase. If the result of step 606 is negative, the steps of this Figure are terminated and step 506 of FIG. 5. is proceeded to directly.

If the result of step 606 is positive, during a step 607, calculation is made of the correction image Corr(I_{R}(t)) or corrective signal which was given rise to by the drift in the case of a resolution increase. This correction image Corr(I_{R}(t)) is calculated in the following manner when the resolution R (resolution for the image at time t) is passed to from the resolution R−1 (resolution of the image for the time t−1).

Corr(I_{R}(t))=I_{R}(t)−Comp_{[I}_{_{R}}_{(t-1)→I}_{_{R}}_{(t)]}{Up(I_{R-1}(t−1)}−Res(I_{R}(t)) (3)

In which equation I_{R}(t) is the reconstructed image of resolution R at the time t and Comp_{[I}_{_{R}}_{(t-1)→I}_{_{R}}_{(t)]} corresponds to the motion compensation.

In similar manner to the case of the reduction in resolution, when an increase in resolution is carried out at the time t, the image of the new resolution at the preceding time, I_{R}(t−1), is not available at the decoder, and thus an approximation of this image must be calculated. In the example given here, this approximation is a version, upsampled to reach the new resolution R, of the reference image at the resolution R−1, which is available: this is the term UP(I_{R-1}(t−1)).

As this upsampled reference image is different from the reference image for the resolution R, I_{R}(t−1), the correction image Corr(I_{R}(t)) is calculated to reduce that difference in order to reduce the drift from the motion compensation.

The following steps, 608 to 610 respectively correspond to the steps 603 to 605. Then step 506 illustrated in FIG. 5 is returned to.

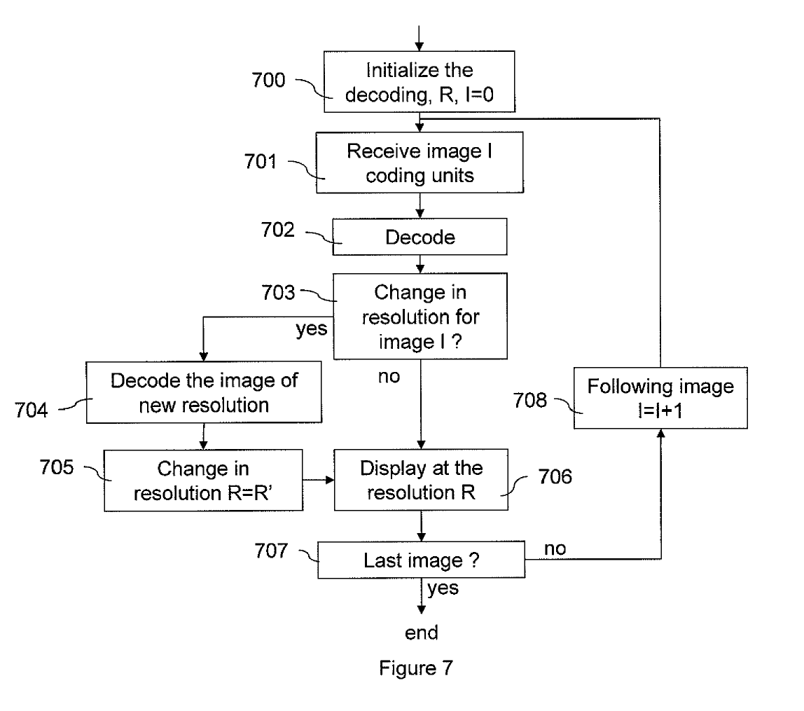

FIG. 7 represents the different steps of operation of the decoder situated at the client in a particular embodiment of the method of the present invention.

During a step 700, an initialization of the decoding of the video sequence is carried out. The initial spatial resolution can thus be selected for the decoding R of the coded sequence. For example, in the application context relative to video streaming, sessions implementing the RTSP and RTP protocols are then created and the broadcast of the coding units over the network may commence. Furthermore, during this step 700, the value of the image counter I is initialized to “0”.

Next, during a step 701, coding units are received and the video data coded relative to the image I in course of being processed are extracted.

Next, during a step 702, the decoding is carried out of the coding units as is done by a conventional SVC decoder.

During a step 703, it is determined whether a change in resolution occurs for the image 1. In a first mode, this detection may be made via an item of information transmitted in accordance with the RTSP protocol, by means of the “SET PARAMETER” commands exchanged between the server and the client, in course of streaming. The server may thus inform the client that a corrective coding unit (for reduction or increase in resolution) is associated with the image of index 1. In another embodiment, the detection of resolution change is carried out as soon as a coding unit of “discardable” type is received corresponding to the image of index I in course of processing. It is noted that the two preceding embodiments may be combined, in particular in case discardable coding units are used for other purposes than those described here.

If the result of step 703 is negative, step 706 is proceeded to during which the decoded image is displayed.

On the other hand If the result of step 703 is positive, a change in spatial resolution is detected. The decoding of the image of new resolution R′ is then carried out during a step 704. As in the case of the coding, two cases are distinguished depending on whether there is an increase R′=R+1 or a reduction R′=R−1 in the spatial resolution.

In the case of a reduction in resolution, the decoding is carried out in the following manner corresponding to the calculation step made on coding. The new decoded image is calculated on the basis of the following expression in which the corrective signal resulting from the decoding of the corrective coding unit received is added in order to correct the error introduced by the replacement of the reference image:

I_{R′}(t)=Comp_{[I}_{_{R′}}_{(t-1)→I}_{_{R′}}_{(t)]}{Down(I_{R′+1}(t−1)}+Res(I_{R′}(t))+Corr(I_{R′}(t) (4)

In formula (4), the expression Comp_{[I}_{_{R′}}_{(t 1)→I}_{_{R′}}_{(t)]} corresponds to the motion compensation and the expression Down(I_{R′+1}(t−1)) corresponds to the operation of downsampling the image (t−1) from the resolution R′+1. The term Corr(I_{R′}(t)) corresponds to the decoded content of the corrective coding unit inserted into the bitstream.

In the case of an increase in resolution, the decoding will be carried out in the following manner corresponding to the reverse step made on coding. The new decoded image will be calculated on the basis of the following expression:

I_{R′}(t)=Comp_{[I}_{_{R′}}_{(t-1)→I}_{_{R′}}_{(t)]}{Up(I_{R′-1}(t−1)}+Res(I_{R′}(t))+Corr(I_{R′}(t) (5)

In formula (5), the expression Comp_{[I}_{_{R′}}_{(t 1)→I}_{_{R′}}_{(t)]} corresponds to the motion compensation and the expression UP(I_{R′-1}(t−1)) corresponds to the operation of upsampling the image (t−1) from the resolution R′−1. The term Corr(I_{R′}(t)) corresponds to the decoded content of the corrective coding unit inserted into the bitstream.

During a step 705, the resolution variable R takes the value R′. This makes it possible in particular to adjust the display size of the new resolution. Then, during a step 706, the decoded image is displayed.

Step 707 is proceeded to next in order to determine whether it is the last image of the sequence to decode. If yes, the decoding of the sequence is terminated. In the opposite case, a step 708 is proceeded to during which the image counter I is incremented in order to pass to the following image, then step 701 is returned to.

In the embodiment described above, a corrective coding unit is used to obtain an image for a time t on the basis of a reference image of different resolution for a time t−1. Numerous variants of this particular embodiment of the present invention are obvious for the person skilled in the art on the basis of the following indications:

in variants, a corrective coding unit is used to obtain a reference image for the image corresponding to the time t on the basis of a reference image of different resolution for a time t−1, formula (1) then being replaced by the following formula:

Corr(I_{R}(t−1))=I_{R}(t−1)−{Down(I_{R+1}(t−1)}

in variants, a corrective coding unit is used to obtain a motion compensated reference image for the image corresponding to the time t on the basis of a reference image of different resolution for a time t−1, the residue being processed on decoding and formula (1) then being replaced by the following formula:

Corr(I_{R}(t))=I_{R}(t)−Comp_{[I}_{_{R}}(t−1)→I_{_{R}}_{(t)]}{Down(I_{R+1}(t−1)}

in variants, a corrective coding unit is used to obtain a reference image added to the residue for the image corresponding to the time t on the basis of a reference image of different resolution for a time t−1, the motion compensation being processed on decoding and formula (1) then being replaced by the following formula:

Corr(I_{R}(t))=I_{R}(t)−{Down(I_{R+1}(t−1)}−Res(I_{R}(t)).

It is observed that, in the case where two preceding reference images are used, formula (1) becomes

Corr(I_{R}(t))=I_{R}(t)−Comp_{[I}_{_{R}}_{(t-1)→I}_{_{R}}_{(t)]}{Down(I_{R+1}(t−1)}−Res(I_{R}(t))−Comp_{[I}_{_{R}}_{(t-2)→I}_{_{R}}_{(t)]}{Down(I_{R+1}(t−2)}

1- A method of transmitting image data of a sequence of images, that comprises, for at least one image of said sequence of images:
a step of coding an initial image at a first resolution,
a step of determining a corrective signal representing the difference between the image temporally following the initial image at a second resolution and an image at the second resolution calculated from the initial image at the first resolution,
a step of coding said corrective signal and
a step of transmitting the coded image at the first resolution and the coded corrective signal.

2- A method according to claim 1, wherein, during the step of determining a corrective signal, the corrective signal is determined as being an image equal to the difference between:
the following image at the second resolution and
the sum of:
the initial image at the first resolution, coded and decoded at the first resolution, re-sampled to reach the second resolution and compensated with the compensation between the reference image of the following image and the following image at the second resolution and
a residue at the second resolution.

3- A method according to claim 1, wherein, during the step of determining a corrective signal, the corrective signal represents the difference between the initial image at the first resolution re-sampled at the second resolution and a reference image of the following image coded at the second resolution.

4- A method according to claim 3, that further comprises a step of detecting spatial resolution change, to reach a second resolution on the basis of the image following the initial image, the step of determining the corrective signal being carried out after the detecting step.

5- A method according to claim 1, that further comprises a step of detecting spatial resolution change, to reach a second resolution on the basis of the image following the initial image, the step of determining the corrective signal being carried out after the detecting step.

6- A method according to claim 1, wherein, for images of an image stream, for at least one possible change in spatial resolution, the step of determining a corrective signal, the step of coding said corrective signal and a step of conjoint memory storage of the coded corrective signal and of the coded images to constitute a data stream to transmit, are regularly performed, and during the transmitting step, a coded corrective signal is only transmitted in case of detection of resolution change.

7- A method according to claim 6, wherein, during the step of coding the corrective signal, the corrective signal is associated with a specific identifier.

8- A method according to claim 1, wherein, during the step of coding the corrective signal, the corrective signal is associated with a specific identifier.

9- A method according to claim 8, wherein the coding of the corrective signal is carried out by coding unit and the specific identifier is inserted in a header of each coding unit representing the corrective signal.

10- A method according to claim 1, wherein, during each coding step, an image is coded with a hierarchical format.

11- A method according to claim 10, wherein, during each coding step, SVC coding is used (SVC being an acronym for “Scalable Video Coding”).

12- A method according to claim 11, wherein, during the step of coding the corrective signal, at least one SVC coding unit is created encapsulating the corrective signal in at least one item of syntax to create an optional coding unit in the data stream.

13- A method of receiving image data of a sequence of images, that comprises, for at least one image of said sequence of images:
a step of decoding an initial image at a first resolution,
a step of decoding a corrective signal representing the difference between the image temporally following the initial image at a second resolution and an image at the second resolution calculated from the initial image at the first resolution and
a step of decoding the following image, at the second resolution, by using the initial image decoded at the first resolution and said corrective signal.

14- A method according to claim 13, that further comprises a step of detecting change in spatial resolution, during which the reception of a said coded corrective signal is detected, the step of decoding the corrective signal and the step of decoding the following image being carried out after detection of a change of spatial resolution.

15- A method according to claim 13, wherein, during the step of decoding the following image, the following image is determined as equal to the sum of:
a corrective image represented by the corrective signal and
the sum of:
the initial image at the first resolution re-sampled to reach the second resolution and compensated with the compensation between the reference image of the following image and the following image at the second resolution and
a residue at the second resolution.

16- A method according to claim 12, wherein, during the step of decoding the following image, the following image is determined as equal to the sum of:
a corrective image represented by the corrective signal and
the sum of:
the initial image at the first resolution re-sampled to reach the second resolution and compensated with the compensation between the reference image of the following image and the following image at the second resolution and
a residue at the second resolution.

17- A device for transmitting image data of a sequence of images, that comprises:
a means for coding an initial image at a first resolution,
a means for determining a corrective signal representing the difference between the image temporally following the initial image at a second resolution and an image at the second resolution calculated from the initial image at the first resolution,
a means for coding said corrective signal and
a means for transmitting the coded image at the first resolution and the coded corrective signal.

18- A device for receiving image data of a sequence of images, that comprises:
a means for decoding an initial image at a first resolution,
a means for decoding a corrective signal representing the difference between the image temporally following the initial image at a second resolution and an image at the second resolution calculated from the initial image at the first resolution,
a means for decoding the following image, at the second resolution, by using the initial image decoded at the first resolution and said corrective signal.

19- A computer program that can be loaded into a computer system, said program containing instructions enabling the implementation of the method according to claim 1.

20- A removable or non-removable carrier for computer or microprocessor readable information, storing instructions of a computer program, that makes it possible to implement the method according to claim 1.
